(19) United States
(12) Patent Application Publication
(10) Pub. No.: US 2008/0305335 A1
(43) Pub. Date: Dec. 11, 2008

(54) CORE-SHELL STRUCTURED SILICONE RUBBER GRAFT POLYMERS, IMPACT-RESISTANT MODIFIED MOLDING COMPOUNDS AND MOLDED BODIES AND METHOD FOR PRODUCING THE SAME

(75) Inventors: Klaus SCHULTES, Wiesbaden (DE); Reiner Mueller, Biebesheim (DE); Werner Hoess, Griesheim (DE); Klaus Albrecht, Mainz (DE)

Correspondence Address: OBLON, SPIVAK, MCCLELLAND MAIER & NEUSTADT, P.C., 1940 DUKE STREET, ALEXANDRIA, VA, 22314, US

(73) Assignee: ROEHM GmBH & CO. KG, Darmstadt (DE)

(21) Appl. No.: 11/970,190

(22) Filed: Jan. 7, 2008

Related U.S. Application Data
(63) Continuation of application No. 11/748,874, filed on May 15, 2007, now abandoned.
Application No. 11/748,874 is a continuation of application No. 10/501,467, filed on Jul. 14, 2004, now abandoned.

(30) Foreign Application Priority Data
Feb. 6, 2002 (DE) 102 06 518.7
Aug. 7, 2002 (DE) 102 36 240.8

(51) Int. Cl. B32B 15/02; C08F 283/12

(52) U.S. Cl. 428/402.24; 522/99

(57) ABSTRACT

The invention relates to core-shell structured silicone rubber graft polymers that comprise a core a) from a silicium-organic polymer that corresponds to the general formula (R2SiO2/2)x.(RSiO3/2)y.(SiO4/2)z, wherein x=0 to 99.5 mole %, y=0.5 to 100 mole %, z=0 to 50 mole %, wherein R is the same or different and represents alkyl or alkenyl groups having 1 to 6 C atoms, aryl groups or substituted hydrocarbon groups and at last one shell c) from an organic polymer. The silicone rubber graft copolymers are obtained by producing the organic shell c) by radical polymerization at a temperature of not more than 65° C. and adding the initiator in at least two portions to the reaction vessel, with a further addition at least 2 minutes after start of the polymerization.

This is a continuation application of U.S. application Ser. No. 11/748,874, filed May 15, 2007, which a continuation application of U.S. application Ser. No. 10/501,467, filed Jul. 14, 2004, which is a 371 of PCT/EP03/00267 filed on Jan. 14, 2003.

The present invention relates to silicone rubber graft copolymers with core-shell structure and to impact-resistant molding compositions and moldings obtainable therefrom, and also to processes for their production.

Various applications require moldings which have to have excellent impact resistance, even at low temperatures. Among these are, by way of example, components for refrigerators, pipes, and automobiles which may be exposed to low temperatures.

In order to achieve this property, plastics are equipped with what are known as impact modifiers. These additives are well-known.

For example, silicone rubber graft copolymers which have a core-shell structure (C/S) are in particular used to improve impact resistance. Some of these modifiers also have a structure in which two shells are present (C/S1/S2).

EP 430 134 discloses the preparation of modifiers for improving the impact resistance of molding compositions. Here, a core, composed of a silicone rubber and of a polyacrylate rubber, is grafted with vinyl monomers. The material is then used for the impact-modification of molding compositions—however, the only molding compositions mentioned here are polycarbonate (PC) and/or polyester molding compositions.

The document U.S. Pat. No. 4,690,986 describes an impact-resistant molding composition which is prepared from a graft copolymer (via emulsion polymerization). The graft copolymer is a C/S product. The core is composed, inter alia, of a crosslinking agent (siloxane having a methacrylate group bonded via two or more CH₂ groups) and of tetrafunctional silane in the form of crosslinking agent. Both the molding composition and a preparation process are described.

JP 612,135,462 describes a molding composition which is prepared from a graft copolymer (via emulsion polymerization). The graft copolymer is composed of siloxane grafted with vinyl monomer.

EP 309 198 discloses a molding composition composed of PMMI and of grafted polysiloxane. The graft polysiloxane is prepared via grafting of monomers and of at least one “graft-crosslinking agent”. In the subclaims it is clear that the graft-crosslinking agent is the crosslinking agent described in U.S. Pat. No. 4,690,986 (siloxane having a methacrylate group bonded via two or more CH₂ groups). The tetrafunctional silane is also mentioned as crosslinking agent in the subclaims.

EP 332 188 describes graft copolymers which are similar to those described in EP 430134. These graft copolymers are used for modifying molding compositions. In the example, particles are grafted with styrene and these are used for modifying a polyether/polysulfone blend.

DE 43 42 048 discloses graft copolymers with a C/S1/S2 structure. A silicone rubber functions as core, S1 is predominantly prepared from acrylates (min. 70%), and for preparing the shell S2 use may be made, for example, of monomer mixtures in which from 50 to 100% of methyl methacrylate are present. The subclaims also describe impact-resistant molding compositions based on the graft copolymers described, and here again the polymer for the matrix is very broadly interpreted.

DE 3839287 describes a molding composition which is composed of from 20 to 80% of conventional polymers and from 80 to 20% of graft copolymers. The graft copolymer has C/S1/S2 structure, the core being composed of silicone rubber and S1 of polyacrylate rubber. S2 is prepared via redox polymerization (emulsion) of a very wide variety of monomers. The only example listed is an impact-modified SAN molding composition.

The publication WO 99141315 discloses dispersions which include a mixture of particles composed of vinyl copolymers and composed of PMMA-encapsulated silicone rubber. This dispersion can be used as impact modifier, inter alia.

EP 492 376 describes graft copolymers which have a C/S or C/S1/S2 structure. The core and the optional intermediate shell are composed of silicone rubber and are more precisely defined—the outer shell is prepared by emulsion polymerization of a very wide variety of monomers.

A particular problem is that the addition of large amounts of additives can impair the mechanical properties of the plastics, and the total amounts that can be added are therefore very restricted.

Furthermore, many articles are used both at very high and at very low temperatures. Among these, by way of example, are automobiles which in winter in cold regions have exposure down to −40° C. However, in desert regions these vehicles are used at temperatures above 50° C.

However, a problem with known impact modifiers is that the improvement in the impact resistance values is temperature-dependent.

In the light of the prior art stated and discussed herein, it was therefore an object of the present invention to provide modifiers which give excellent results when used to render molding compositions impact-resistant. The molding compositions should have good mechanical properties.

Another object of the invention was that the modifiers and the molding compositions should be capable of low-cost preparation.

Another object underlying the invention was to provide modifiers which markedly improve the impact resistance of molding compositions over a wide temperature range.

In addition, it was therefore an object of the present invention to provide impact-resistant molding compositions which can be processed using known shaping processes.

Another object of the present invention was to provide impact-resistant and weathering-resistant moldings with excellent mechanical properties and having high impact resistance beginning at a temperature of −40° C. and above that temperature.

The silicone rubber graft copolymer described in claim 1 with core-shell structure achieved these objects and also achieved other objects which, although they are not specifically mentioned, are obvious or necessary consequences of the circumstances discussed herein. Useful versions of the inventive silicone rubber graft copolymers are protected by the subclaims dependent on claim 1.

Claim 17 achieves the underlying object in relation to the production process.

The measures discussed in claim 20 achieve the object in relation to the impact-resistant molding compositions.

The subject matter of claim 26 provides moldings. Useful versions and inventive embodiments are provided in each case in the subclaims dependent on the subject matters.

Modifiers which can give excellent results when used to improve the impact resistance of molding compositions are successfully provided if the organic shell c) of a silicone rubber graft copolymer with core-shell structure is prepared via free-radical polymerization at a temperature of not higher than 65° C., where the initiator is added in at least two portions to the reaction vessel and a further addition takes places at least 2 minutes after the start of the polymerization, where the silicone rubber graft copolymers encompass at least one core a) composed of organosilicon polymer which has the general formula (R₂SiO_{2/2})ₓ.(RSiO_{3/2})_{y}.(SiO_{4/2})_{z} where x=from 0 to 99.5 mol %, y=from 0.5 to 100 mol %, z=from 0 to 50 mol %, where R means identical or different alkyl or alkenyl radicals having from 1 to 6 carbon atoms, aryl radicals, or substituted hydrocarbon radicals, and also at least one shell c) composed of an organic polymer.

The inventive measures achieve, inter alia, in particular the following advantages: [symbol]
Molding compositions equipped with the inventive silicone rubber graft copolymers exhibit very good performance at low temperatures. For example, very good impact resistance values are achieved in particular at temperatures below 0° C. [symbol]
Silicone rubber graft copolymers of the present invention are capable of low-cost preparation. [symbol]
Relatively small amounts of inventive silicone rubber graft copolymers are sufficient to achieve a specified impact resistance. [symbol]
Molding compositions in which the inventive silicone rubber graft copolymers are present can be processed in a known manner. [symbol]
Moldings which have been obtained from the molding compositions taught in the present invention exhibit an excellent modulus of elasticity. For example, particular embodiments exhibit a modulus of elasticity to ISO 527-2 of at least 1500 MPa, preferably at least 1600 MPa, particularly preferably at least 1700 MPa. [symbol]
Inventive moldings are very heat-resistant and weathering-resistant. The Vicat softening point (ISO 306 (B50)) of preferred moldings is above 85° C., preferably above 90° C., and particularly preferably above 95° C.

The core a) of the inventive silicone rubber graft copolymer encompasses organosilicon polymer which has the general formula (R₂SiO_{2/2})ₓ.(RSiO_{3/2})_{y}.(SiO_{4/2})_{z} where x=from 0 to 99.5 mol %, y=from 0.5 to 100 mol %, z=from 0 to 50 mol %, where R means identical or different alkyl or alkenyl radicals having from 1 to 6 carbon atoms, aryl radicals, or substituted hydrocarbon radicals.

The radicals R are preferably alkyl radicals, such as the methyl, ethyl, n-propyl, isopropyl, n-butyl, sec-butyl, amyl, hexyl radical; alkenyl radicals, such as the ethenyl, propenyl, butenyl, pentenyl, hexenyl, and allyl radical; aryl radicals, such as the phenyl radical; or substituted hydrocarbon radicals.

Examples of these are halogenated hydrocarbon radicals, such as the chloromethyl, 3-chloropropyl, 3-bromopropyl, 3,3,3-trifluoropropyl, and 5,5,5,4,4,3,3-heptafluoropentyl radical, and also the chlorophenyl radical; mercaptoalkyl radicals, such as 2-mercaptoethyl and 3-mercaptopropyl radicals; cyanoalkyl radicals, such as the 2-cyanoethyl and 3-cyanopropyl radical; aminoalkyl radicals, such as the 3-aminopropyl radical; acryloxyalkyl radicals, such as the 3-acryloxypropyl and 3-methacryloxypropyl radical; hydroxyalkyl radicals, such as the hydroxypropyl radical.

Particular preference is given to the radicals methyl, ethyl, propyl, phenyl, ethenyl, 3-methacryloxypropyl and 3-mercaptopropyl, and it is preferable here that less than 30 mol % of the radicals in the siloxane polymer are ethenyl, 3-methacryloxypropyl, or 3-mercaptopropyl groups.

In one particular aspect of the present invention, the core a) has vinyl groups prior to grafting. This group may have direct bonding to an Si atom, or have bonding via an alkylene radical, such as methylene, ethylene, propylene, and butylene. The inventive vinyl groups of the core a) may therefore be obtained, inter alia, via use of organosilicon compounds which have ethenyl, propenyl, butenyl, pentenyl, hexenyl, and/or allyl radicals.

The content of vinyl groups in the core a) prior to grafting is in particular in the range from 0.5 to 10 mol %, preferably from 1 to 6 mol %, and particularly preferably from 2 to 3 mol %. The mol % data represent the molar proportion of the vinyl-containing starting compounds, which for the purposes of calculation have one vinyl group, based on all of the monomeric organosilicon compounds used to prepare the core a).

In one preferred embodiment, the vinyl groups have inhomogeneous distribution in the silicone core, the proportion in the outer region of the silicone core being higher than in the region of the centre of gravity of the core. The location of 85%, particularly 90%, of all of the vinyl groups is preferably in the outer shell of the silicone core. This outer shell of the silicone core is formed by 40% of the radius, and the volume of the outer shell is therefore specified via the formula V=4π/3*r³−4π/3*(0.6*r)³.

The organosilicon shell polymer b) is preferably composed of dialkylsiloxane units (R₂SiO_{2/2}), where R means methyl or ethyl.

The organic shell c) is composed of polymers which are obtainable via free-radical polymerization of monomers which contain a double bond. Monomers of this type are well-known to the person skilled in the art.

Among these are, inter alia, 1-alkenes, such as 1-hexene, 1-heptene; branched alkenes, such as vinylcyclohexane, 3,3-dimethyl-1-propene, 3-methyl-1-diisobutylene, 4-methyl-1-pentene;
acrylonitrile;
vinyl esters, such as vinyl acetates;
styrene, substituted styrenes having an alkyl substituent in the side chain, e.g. α-methylstyrene and α-ethylstyrene, substituted styrenes having an alkyl substituent on the ring, such as vinyltoluene and p-methylstyrene, halogenated styrenes, such as monochlorostyrenes, dichlorostyrenes, tribromostyrenes, and tetrabromostyrenes;
heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles, and hydrogenated vinylthiazoles, vinyloxazoles, and hydrogenated vinyloxazoles;
vinyl and isoprenylethers;
maleic acid derivatives, such as maleic anhydride, methyl maleic anhydride, maleinimide, methylmaleinimide; and
dienes, such as divinylbenzene.

(Meth)acrylates are a particularly preferred group of monomers. The term (meth)acrylates encompasses methacrylates and acrylates, and also mixtures of the two.

These monomers are well known. Among them are, inter alia, (meth)acrylates derived from saturated alcohols, e.g. methyl (meth)acrylate, ethyl (meth)acrylate, propyl (meth)acrylate, n-butyl (meth)acrylate, tert-butyl (meth)acrylate, pentyl (meth)acrylate and 2-ethylhexyl (meth)acrylate; (meth)acrylates derived from unsaturated alcohols, e.g. oleyl (meth)acrylate, 2-propynyl (meth)acrylate, allyl (meth)acrylate, vinyl (meth)acrylate;
aryl (meth)acrylates, such as benzyl (meth)acrylate or phenyl (meth)acrylate, where each of the aryl radicals may be unsubstituted or have up to four substituents; cycloalkyl (meth)acrylates, such as 3-vinylcyclohexyl (meth)acrylate, bornyl (meth)acrylate;
hydroxyalkyl (meth)acrylates, such as
3-hydroxypropyl (meth)acrylate,
3,4-dihydroxybutyl (meth)acrylate,
2-hydroxyethyl (meth)acrylate, 2-hydroxypropyl (meth)acrylate;
glycol di(meth)acrylates, such as 1,4-butanediol di(meth)acrylate,
(meth)acrylates of ether alcohols, such as tetrahydrofurfuryl (meth)acrylate, vinyloxyethoxyethyl (meth)acrylate;
amides and nitriles of (meth)acrylic acid, e.g. N-(3-dimethylaminopropyl)(meth)acrylamide,
N-(diethylphosphono)(meth)acrylamide,
1-methacryloylamido-2-methyl-2-propanol;
sulphur-containing methacrylates, such as
ethylsulphinylethyl (meth)acrylate,
4-thiocyanatobutyl (meth)acrylate,
ethylsulphonylethyl (meth)acrylate,
thiocyanatomethyl (meth)acrylate,
methylsulphinylmethyl (meth)acrylate,
bis((meth)acryloyloxyethyl) sulphide;
multifunctional (meth)acrylates, such as
trimethylolpropane tri(meth)acrylate.

These monomers may be used individually or in the form of a mixture. Particular preference is given here to mixtures in which methacrylates and acrylic esters are present. These mixtures may encompass the other monomers which are copolymerizable with these (meth)acrylates. These monomers have likewise been mentioned above.

In one particular aspect of the present invention, the free-radical polymerization reaction between the monomers which form the shell is faster than their reaction with the double bonds in the silicone rubber particles.

For the purposes of the present invention, to determine the polymerization rates of the various monomers it is sufficient to make an estimate via the copolymerization parameters. By way of example, these copolymerization parameters are defined, inter alia, in B. Vollmert, Grundriβ der Molekularen Chemie [Basic principles of molecular chemistry], Volume I Strukturprinzipien Polymersynthesen I [Polymerisation], [Structural principles of polymer syntheses I], E. Vollmert-Verlag Karlsruhe 1988, p. 114 et seq. Since the parameters for the double bonds in the silicone particles are not available, the parameters for the relevant monomers may be considered. The copolymerization parameters may be either determined, calculated via the corresponding e and Q values, or found in the literature (see, for example, the abovementioned reference and references cited therein).

In one preferred embodiment, polymerization between the monomers which form the shell takes place at least twice as rapidly as their polymerization with the double bonds in the silicone rubber particles.

The preferred methacrylate is methyl methacrylate. Preference is moreover given to acrylic esters which encompass from 1 to 8 carbon atoms. Among these are methyl acrylate, ethyl acrylate, propyl acrylate, n-butyl acrylate, tert-butyl acrylate, pentyl acrylate, hexyl acrylate, and 2-ethylhexyl (meth)acrylate. Particular preference is given to mixtures in which methylmethacrylate and at least one of the abovementioned acrylic esters having from 1 to 8 carbon atoms are present. Particular preference is given to mixtures in which methyl methacrylate and ethyl acrylate are present.

The ratio of acrylic ester to methacrylate can vary widely. The ratio by weight of acrylic ester to methacrylate in the mixture for preparing the shell c) is preferably in the range from 50:50 to 1:99, particularly preferably in the range from 10:90 to 2:98, and very particularly preferably in the range from 5:95 to 3:97, with no intended resultant restriction.

The ratio of the weight of core a) and shell b) to the weight of the shell c) in the silicone rubber graft copolymers is preferably in the range from 90:10 to 20:80, in particular from 80:20 to 30:70, and particularly preferably from 70:30 to 55:65, with no intended resultant restriction.

According to one particular aspect of the present invention, the silicone rubber graft copolymers are composed of from 0.05 to 95% by weight, based on the total weight of the copolymer, of a core a) composed of an organosilicon polymer which has the general formula (R₂SiO_{2/2})ₓ.(RSiO_{3/2})_{y}.(SiO_{4/2})_{z} where x=from 0 to 99.5 mol %, y=from 0.5 to 100 mol %, z=from 0 to 50 mol %, where R means identical or different alkyl or alkenyl radicals having from 1 to 6 carbon atoms, aryl radicals, or substituted hydrocarbon radicals, from 0 to 94.5% by weight, based on the total weight of the copolymer, of a polydialkylsiloxane layer b), and from 5 to 95% by weight, based on the total weight of the copolymer, of a shell c) composed of organic polymers.

According to one preferred embodiment, the silicone rubber graft copolymers have a particle size in the range from 5 to 500 nm, in particular from 10 to 300 nm, and particularly preferably from 30 to 200 nm. The particle size is based on the largest dimension of the particles. In the case of spherical particles, the particle size is given by the particle diameter.

In another aspect of the present invention, the silicone rubber graft copolymers have monomodal distribution with a polydispersity index of not more than 0.4, in particular not more than 0.2, with no intended resultant restriction.

The particle size may be measured using particle size determination equipment whose function uses the principle of photon correlation spectroscopy, obtainable from Coulter with the trade name Coulter N4, in water at room temperature (23° C.). This determination equipment is tested using appropriate reference lattices of varying particle size, the particle size of which is determined via ultracentrifuge measurements. The particle size is therefore based on an average determined by the abovementioned method.

The polysiloxane graft base may be prepared by the emulsion polymerization process. Here, from 0.05 to 95% by weight, based on the total weight of the graft copolymer to be prepared, of one or more monomeric silanes of RₐSi(OR′)₄₋ₐ type, where a=0, 1, or 2, are metered into an emulsifier/water mixture which is kept in motion. The radical R′ represents alkyl radicals having from 1 to 6 carbon atoms, aryl radicals, or substituted hydrocarbon radicals, preference being given to methyl, ethyl, and propyl radicals. The radical R is as defined above.

Suitable emulsifiers are carboxylic acids having from 9 to 20 carbon atoms, aliphatically substituted benzenesulfonic acids having at least 6 atoms in the aliphatic substituents, aliphatically substituted naphthalenesulfonic acids having at least 4 carbon atoms in the aliphatic substituents, aliphatic sulfonic acids having at least 6 carbon atoms in the aliphatic radicals, silylalkylsulfonic acids having at least 6 carbon atoms in the alkyl substituents, aliphatically substituted diphenyl ether sulfonic acids having at least 6 carbon atoms in the aliphatic radicals, alkyl hydrogensulfates having at least 6 carbon atoms in the alkyl radicals, quaternary ammonium halides or quaternary ammonium hydroxides. All of the acids mentioned may be used in unmodified form or, where appropriate, in a mixture with their salts. If use is made of anionic emulsifiers, it is advantageous to use those whose aliphatic substituents contain at least 8 carbon atoms. Preferred anionic emulsifiers are aliphatically substituted benzenesulfonic acids. If use is made of cationic emulsifiers, it is advantageous to use halides. The amount of emulsifier to be used is from 0.5 to 20.0% by weight, preferably from 1.0 to 3.0% by weight, based in each case on the amount of organosilicon compounds used. The silane or the silane mixture is added as a feed. The emulsion polymerization is carried out at a temperature of from 30 to 90° C., preferably from 60 to 85° C. In one preferred aspect of the present invention, the core a) is prepared at atmospheric pressure.

The pH of the polymerization mixture may vary widely. This value is preferably in the range from 1 to 4, particularly preferably from 2 to 3.

The polymerization to prepare the graft base may be carried out either continuously or else batchwise. Of these methods, batchwise preparation is preferred.

In the continuous method, the residence time in the reactor is generally from 30 to 60 minutes, with no intended resultant restriction.

In batchwise preparation of the graft base, it is advantageous for the stability of the emulsion to continue stirring for from 0.5 to 5.0 hours after the feed has ended. In one preferred embodiment, for further improvement of the stability of the polysiloxane emulsion, alcohol liberated during the hydrolysis can be removed by distillation, especially if the proportion of silane of the general formula RSi(OR′)₃ is high.

In the first step of the reaction, the constitution of the silane phase, the feed amount of which is from 0.05 to 95% by weight, based on the total weight of the graft copolymer, and which has one or more components, comprises from 0 to 99.5 mol % of a silane of the general formula R₂Si(OR′)₂ or of an oligomer of the formula (R₂SiO)ₙ, where n=from 3 to 8, from 0.5 to 100 mol % of a silane of the general formula RSi(OR′)₃, and from 0 to 50 mol % of a silane of the general formula Si(OR′)₄, where the mol % data are in each case based on the overall constitution of the graft base.

Examples of silanes of the general formula R₂Si(OR′)₂ are dimethyldiethoxysilane or dimethyldimethoxysilane. Examples of oligomers of the formula (R₂SiO)ₙ, where n=from 3 to 8, are octamethylcyclotetrasiloxane or hexamethylcyclotrisiloxane.

Examples of silanes of the general formula RSi(OR′)₃ are methyltrimethoxysilane, phenyltriethoxysilane, vinyltrimethoxysilane, 3-chloropropyltrimethoxysilane, 3-mercaptopropyltrimethoxysilane and methacryloxy-propyltrimethoxysilane.

Examples of silanes of the general formula Si(OR′)₄ are tetramethoxysilane or tetraethoxysilane. In one preferred embodiment, the graft base is also grafted with the organosilicon shell polymer b) prior to the grafting-on of the ethylenically unsaturated monomers.

This shell b) is likewise prepared by the emulsion polymerization process. For this, difunctional silanes of the general formula R₂Si(OR′)₂ or low-molecular-weight siloxanes of the general formula (R₂SiO_{2/2})ₙ, where n=from 3 to 8, are metered into the emulsion of the graft base, the emulsion being kept in motion. The radicals R and R′ here are as defined above. It is preferable not to add any further emulsifier, because the amount of emulsifier present in the emulsion is generally sufficient for stabilization.

The polymerization for grafting-on of the shell b) is carried out at a temperature of from 15 to 90° C. and preferably from 60 to 85° C. Operations here are usually carried out at atmospheric pressure. The pH of the polymerization mixture is from 1 to 4, preferably from 2 to 3. This step of the reaction, too, may take place either continuously or else batchwise. The residence times in the reactor for continuous preparation, and the continued stirring times in the reactor in the case of batchwise preparation, depend on the amount metered in of silanes or siloxanes and are preferably from 2 to 6 hours. In the most advantageous method, the steps of the reaction for preparing the graft base a) and the shell polymer b) are combined in a suitable reactor, and, where appropriate, the alcohol formed is finally removed by distillation.

The amount metered in of the difunctional silanes of the general formula R₂Si(OR′)₂ or low-molecular-weight siloxanes of the general formula (R₂SiO_{2/2})ₙ, where n=from 3 to 8, are such that the proportion of organosilicon shell polymer is from 0.5 to 94.5% by weight, preferably from 35 to 70% by weight, based on the total weight of the graft copolymer.

The solids content of the resultant siloxane elastomer soles, should be not more than 25% by weight, either with or without organosilicon shell polymer b), because otherwise a large rise in the viscosity makes it difficult to process the soles further in the form of graft base. Polysiloxanes obtainable via coagulation from soles of this type exhibit elastomeric properties. A simple method for characterizing the elasticity is determination of the swell factor by a method based on that given in U.S. Pat. No. 4,775,712. The swell factor should be >3.

In the final step of the preparation process, the abovementioned ethylenically unsaturated monomers are grafted onto the polysiloxane graft base, which has preferably been grafted with the organosilicon shell polymer b). For this, the amount metered in of the organic monomers is preferably from 5 to 95% by weight, particularly preferably from 30 to 70% by weight, based in each case on the total weight of the graft copolymer.

The grafting preferably takes place by the emulsion polymerization process in the presence of water-soluble or monomer-soluble free-radical initiators. Suitable free-radical initiators are water-soluble peroxo compounds, organic peroxides, hydroperoxides, or azo compounds.

Examples of preferred initiators are the azo initiators well known to persons skilled in the art, e.g. AIBN and 1,1-azobiscyclohexanecarbonitrile, and also peroxy compounds, such as methyl ethyl ketone peroxide, acetylacetone peroxide, dilauroyl peroxide, tert-butyl per-2-ethylhexanoate, ketone peroxide, methyl isobutyl ketone peroxide, cyclohexanone peroxide, dibenzoyl peroxide, tert-butyl peroxybenzoate, tert-butylperoxy isopropyl carbonate, 2,5-bis(2-ethylhexanoylperoxy)-2,5-dimethylhexane, tert-butylperoxy 2-ethylhexanoate, tert-butylperoxy 3,5,5-trimethylhexanoate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl) peroxydicarbonate, mixtures of two or more of the abovementioned compounds with one another, and also mixtures of the abovementioned compounds with compounds not mentioned which can likewise form free radicals.

By way of example, K₂S₂O₈, KHSO₅, NaHSO₅, and butyl hydroperoxide are particularly preferably used to initiate the polymerization of the shell.

In particular embodiments, the free-radical initiators are mixed with a reductive component so that the polymerization can be carried out at a lower temperature.

Reductive components of this type are well-known. Among these are, inter alia, ferrous salts, such as FeSO₄, sodium bisulfite, sodium thiosulfate, and sodium hydroxymethylsulfinate (sodium formaldehyde-sulfoxylate).

According to the invention, the shell c) comprises organic polymers which are prepared via free-radical polymerization at a temperature of not higher than 65° C., where the initiator is added in at least two portions to the reaction vessel, where one addition is needed at the start of the polymerization and a further addition takes place at least 2 minutes, preferably at least 10 minutes, and particularly preferably at least 20 minutes, after the start of the polymerization.

The expression “after the start of the polymerization” refers to the juncture at which the formation of free radicals in the presence of monomers takes place to an extent which permits polymerization. This juncture depends on the selected initiator system and on the temperature, and consideration has to be given here to inhibitors, where appropriate.

In preferred embodiments, the initiator is added in three, in particular four, and preferably five or more, portions to the reaction vessel, each addition here taking place after at least 2 minutes, preferably at least 10 minutes, and particularly preferably at least 20 minutes.

The initiator amount added during the polymerization is preferably at least as great as the initiator amount used at the start. In particular embodiments, the ratio by weight of amount added during the polymerization to the initiator amount added at the start is greater than or equal to 5, in particular greater than or equal to 10, and particularly preferably greater than or equal to 20.

It is particularly preferable to add the initiator continuously over a period of at least one hour to the reaction vessel. For the purposes of the present invention, continuously means that small amounts are added over the entire period to the reaction vessel, while the addition rate may vary.

It can be advantageous here for the addition of the monomers to the reaction vessel likewise to take place batchwise or continuously over a period of at least one hour. In preferred embodiments, the monomers and the initiator are added to the reaction mixture over a period of at least two hours.

To simplify the conduct of the reaction, it is advisable to prepare a mixture in which monomers and initiator are present. The period over which this mixture is added to the reaction vessel is preferably at least one hour, preferably two hours.

In one particular embodiment, the concentration of initiator in the reaction vessel is kept at or below 0.05% by weight, preferably at or below 0.03% by weight, based on the entire reaction mixture.

The amount of oxidative component and reductive component used here over the entire course of the reaction is preferably from 0.01 to 4% by weight, with preference from 0.02 to 2% by weight, based on the amount of monomer.

The reaction temperatures depend on the nature of the initiator used and according to the invention are not higher than 65° C., preferably from 0 to 60° C.

In this step of the reaction, too, it is preferable not to add any further emulsifier beyond the emulsifier added in the first stage.

An excessive emulsifier concentration can lead to solubilizate-free micelles, which can function as nuclei for purely organic latex particles. This step of the reaction, too, may be carried out either continuously or else batchwise.

Known processes may be used to isolate the graft copolymers from the emulsion.

By way of example, the particles may be isolated via coagulation of the latices by freezing, salt addition, or addition of polar solvents, or spray drying.

The procedure permits the particle size to be influenced not only via the emulsifier content but also via the reaction temperature, and the pH, and especially via the constitution of the graft copolymers. The average particle size here may be varied from 5 to 500 nm.

The introduction of an organosilicon shell b) brings about better bonding of the organopolymer shell phase c) to the organosilicon graft base.

The inventive silicone rubber graft copolymers may be used to improve the impact resistance of molding compositions. These molding compositions are known per se. They generally comprise, inter alia, polyacrylonitriles, polystyrenes, polyethers, polyesters, polycarbonates, polyvinyl chlorides, styrene-acrylonitrile polymers, and poly(meth)acrylates. These polymers may be present individually or in the form of a mixture in the molding compositions.

Among these, preference is given to molding compositions which encompass poly(meth)acrylates.

Poly(meth)acrylates are known to the person skilled in the art. These polymers are generally obtained via free-radical polymerization of mixtures in which (meth)acrylates are present. Examples of these have been mentioned above.

The compositions to be polymerized may comprise not only the (meth)acrylates described above but also other unsaturated monomers which are copolymerizable with the abovementioned (meth)acrylates. The amount generally used of these compounds is from 0 to 50% by weight, preferably from 0 to 40% by weight, and particularly preferably from 0 to 20% by weight, based on the weight of the monomers, and the comonomers here may be used individually or in the form of a mixture.

Preferred poly(meth)acrylates are obtainable via polymerization mixtures which comprise at least 20% by weight, in particular at least 60% by weight, and particularly preferably at least 80% by weight, of methyl methacrylate, based in each case on the total weight of the monomers to be polymerized.

Use may be made here of various poly(meth)acrylates, differing, by way of example, in molecular weight or in monomeric constitution.

The poly(meth)acrylate molding compositions may moreover comprise other polymers in order to modify the properties. Among these are, inter alia, polyacrylonitriles, polystyrenes, polyethers, polyesters, polycarbonates, and polyvinyl chlorides. These polymers may be used individually or in the form of a mixture, and copolymers derivable from the abovementioned monomers may also be added here to the molding compositions. Among these are in particular styrene-acrylonitrile polymers (SANs), the amount of which added to the molding compositions is preferably up to 45% by weight.

Particularly preferred styrene-acrylonitrile polymers may be obtained via polymerization of mixtures composed of

from 70 to 92% by weight of styrene
from 8 to 30% by weight of acrylonitrile and
from 0 to 22% by weight of other comonomers, based in each case on the total weight of the monomers to be polymerized.

In particular embodiments, the proportion of the poly(meth)acrylates is at least 20% by weight, preferably at least 60% by weight, and particularly preferably at least 80% by weight.

Particularly preferred molding compositions of this type are commercially obtainable from Röhm GmbH & Co. KG with the trademark PLEXIGLAS®.

The weight-average molar mass M̅_{w} of the homo- and/or copolymers to be used according to the invention as matrix polymers may vary widely, and the molar mass here is usually matched to the application and the mode of processing of the molding composition. However, it is usually in the range from 20000 to 1000000 g/mol, preferably from 50000 to 500000 g/mol, and particularly preferably from 80000 to 300000 g/mol, with no intended resultant restriction.

The inventive molding compositions may moreover comprise polyacrylate rubber modifier. Surprisingly, the result here can be excellent impact resistance performance at room temperature (about 23° C.) in the moldings produced from the inventive molding compositions. It is particularly significant that mechanical and thermal properties, such as modulus of elasticity or Vicat softening point, are retained at a very high level. If an attempt is made to achieve a similar notched impact strength performance at room temperature merely by using polyacrylate rubber modifier or silicone rubber graft copolymer, there is a more marked reduction in these values.

Polyacrylate rubber modifiers of this type are known per se. They are copolymers which have a core-shell structure, the core and the shell comprising a high proportion of the (meth)acrylates described above.

Preferred polyacrylate rubber modifiers here have a structure with two shells whose constitution differs.

Particularly preferred polyacrylate rubber modifiers have, inter alia, the following structure:

| | |
|---|---|
| Core: | Polymer with at least 90% by weight methyl methacrylate |
| | content, based on the weight of the core. |
| Shell 1: | Polymer with at least 80% by weight butyl acrylate content, |
| | based on the weight of the first shell. |
| Shell 2: | Polymer with at least 90% by weight methyl methacrylate |
| | content, based on the weight of the second shell. |

By way of example, a preferred polyacrylate rubber modifier may have the following structure:

| | |
|---|---|
| Core: | Copolymer composed of methyl methacrylate (95.7% by weight), |
| | ethyl acrylate (4% by weight), and allyl methacrylate (0.3% |
| | by weight) |
| S1: | Copolymer composed of butyl acrylate (81.2% by weight), |
| | styrene (17.5% by weight), and allyl methacrylate (1.3% by |
| | weight) |
| S2: | Copolymer composed of methyl methacrylate (96% by weight) and |
| | ethyl acrylate (4% by weight) |

The core:shell(s) ratio of the polyacrylate rubber modifiers may vary widely. The core:shell ratio C/S is preferably in the range from 20:80 to 80:20, with preference from 30:70 to 70:30 in the case of modifiers with one shell, or in the case of modifiers with two shells the core:shell 1:shell 2 ratio C/S1/S2 is preferably in the range from 10:80:10 to 40:20:40, particularly preferably from 20:60:20 to 30:40:30.

The particle size of the polyacrylate rubber modifier is usually in the range from 50 to 1000 nm, preferably from 100 to 500 nm, and particularly preferably from 150 to 450 nm, with no intended resultant restriction.

In one particular aspect of the present invention, the ratio by weight of silicone rubber graft copolymer to polyacrylate rubber modifier is in the range from 1:10 to 10:1, preferably from 4:6 to 6:4.

Particular molding compositions are composed of
f1) from 20 to 95% by weight of (meth)acrylate polymers,
f2) from 0 to 45% by weight of styrene-acrylonitrile polymers,
f3) from 5 to 60% by weight of silicone rubber graft copolymers,
f4) from 0 to 60% by weight of polyacrylate-rubber-based impact modifiers, based in each case on the weight of components f1) to f4) and conventional additives.

The moldings may comprise conventional additives of any type. Among these are, inter alia, antistatic agents, antioxidants, mold-release agents, flame retardants, lubricants, dyes, flow promoters, fillers, light stabilizers, and organic phosphorus compounds, such as phosphites or phosphonates, pigments, weathering stabilizers, and plasticizers.

Moldings which have excellent notched impact strength values can be obtained from the molding compositions described above by known processes, such as injection molding or extrusion.

In one particular aspect of the present invention, moldings thus obtained can have a Vicat softening point to ISO 306 (B50) of at least 85° C., preferably at least 90° C., and particularly preferably at least 95° C., a notched impact strength NIS (Izod 180/1eA, 1.8 MPa) to ISO 180 of at least 3.0 kJ/m² at −20° C., and of at least 2.5 kJ/m² at −40° C., a modulus of elasticity to ISO 527-2 of at least 1500 MPa, preferably at least 1600 MPa, particularly preferably at least 1700 MPa.

The inventive molding composition is particularly suitable for producing mirror housings, spoilers for vehicles, pipes, or protective coverings or components for refrigerators.

Inventive examples and comparative examples are used below to describe the invention in further detail, but there is no intention that the invention be restricted to these inventive examples.

### INVENTIVE EXAMPLE 1

5950 g of a silicone rubber dispersion with 2 mol % content of vinyl groups and with 20% by weight solids content are used to form an initial charge in a polymerization tank at 55° C. (external tank temperature control), with stirring. This silicone rubber dispersion without shell c) was prepared by a method based on the examples described on pages 5-7 of EP-0 492 376.

3 g of concentrated acetic acid and 0.0035 g of ferrous sulfate were then added. A sodium hydroxymethylsulfinate solution which comprises 2.8 g of sodium hydroxymethylsulfinate and 50 g of water was then added to the mixture by means of a dropping funnel over a period of about 20 min. At the same time, addition of a mixture in which 739 g of methyl methacrylate and 2 g of butyl hydroperoxide initiator were present was started, the input rate of the mixture of monomer and initiator being set here in such a way that addition of this mixture takes place over a period of 3 hours. Once input has ended, the temperature is kept at 55° C. for a further 30 minutes for continued reaction. The mixture is then cooled to 30° C., and the dispersion is filtered through a DIN 70 sieve fabric.

The resultant silicone rubber graft copolymers have a particle radius of 67 nm, determined using Coulter N4 equipment. The particles have a core/shell ratio (C/S) of 60/40.

The dispersion is frozen at −20° C. and thawed after 2 days. The solid is then filtered off and dried at 60° C.

22.5 g of the resultant particles are mixed by means of an extruder with 77.5 g of polymethyl methacrylate molding composition commercially obtainable as Plexiglas® 7N from Röhm GmbH & Co. KG. Test specimens are produced from the molding compositions by extrusion, and the mechanical and thermal properties of these are measured.

Die swell was determined to DIN 54811 (1984). Softening point is determined to DIN ISO 306 (August 1994); mini-Vicat system (16 h/80° C.). Izod notched impact strength is measured to ISO 180 (1993). Modulus of elasticity is determined to ISO 527-2. The resultant data are presented in table 1.

### COMPARATIVE EXAMPLE 1

Inventive example 1 was in essence repeated. However, a mixture of 3 g of sodium persulfate in 50 g of water were used as initiator, and no acetic acid or ferrous sulfate were used. The temperature of the reactor was moreover set at 80° C. Once input had ended, the temperature was kept at 80° C. for a further 240 minutes.

The resultant dispersion is worked up as described in inventive example 1, the particle ratio here being in the region of 63 nm. The particles have a core/shell ratio (C/S) of 60/40.

22.5 g of the resultant particles are mixed by means of an extruder with 77.5 g of polymethyl methacrylate molding composition commercially obtainable as Plexiglas® 7N from Röhm GmbH & Co. KG.

Mechanical properties were determined as in inventive example 1, the values obtained likewise being listed in table 1.

### INVENTIVE EXAMPLE 2

Inventive example 1 was in essence repeated, but instead of pure methyl methacrylate a mixture composed of 761.3 g of methyl methacrylate and 31.7 g of ethyl acrylate was used as monomer.

The particles were analyzed as in inventive example 1. The radius of the particles was 72 nm and their core/shell ratio was 60/40.

As in inventive example 1, 22.5 g of the resultant particles were incorporated into 77.5 g of polymethyl methacrylate molding composition. The resultant values are likewise listed in table 1.

TABLE 1

| | Inventive | Comparative | Inventive |
|---|---|---|---|
| | example 1 | example 1 | example 2 |
| Die swell [%] | 26.7 | 25.8 | 22.7 |
| Viscosity ηₛ | 2075 | 2376 | 2180 |
| (220° C./5 MPa) | | | |
| [Pa s] | | | |
| Mini-Vicat [° C.] | 98.7 | 98.8 | 100.5 |
| Izod NIS [kJ/m²] | | | |
| 23° C. | 5.25 | 3.77 | 5.6 |
| −20° C. | 4.18 | 3.02 | 5.0 |
| Modulus of elasticity | 2277 | 2312 | 2320 |
| [MPa] | | | |

1: A silicone rubber graft copolymer with core-shell structure, comprising:
at least one core comprising:
a) an organosilicon polymer represented by the following formula
(R₂SiO_{2/2})ₓ.(RSiO_{3/2})_{y}.(SiO_{4/2})_{z}
wherein x=from 0 to 99.5 mol %, y=from 0.5 to 100 mol %, z=from 0 to 50 mol %,
wherein R represents identical or different alkyl or alkenyl radicals having from 1 to 6 carbon atoms, aryl radicals, or substituted hydrocarbon radicals, and
at least one shell c) comprising an organic polymer, prepared by a process which comprises
preparing the organic shell c) by free-radical polymerization of at least one monomer at a temperature of not higher than 65° C. and
adding an initiator in at least two portions to a reaction vessel, a further addition taking place at least 2 minutes after the start of the polymerization;
wherein an initiator system is used in which a reducing agent is present, and
wherein the initiator is added continuously over a period of at least one hour to the reaction vessel and the at least one monomer is added continuously over a period of at least one hour to the reaction vessel, and
wherein the weight ratio of the amount of the initiator added during the polymerization to the amount of the initiator present at the start of polymerization is at least 1.

2: The silicone rubber graft copolymer as claimed in claim 1, wherein the initiator is added in at least three portions to the reaction vessel, each addition taking place after at least 2 minutes.

3-4. (canceled)

5: The silicone rubber graft copolymer as claimed in claim 1, wherein the monomers and the initiator are added in the form of a mixture to the reaction vessel.

6: The silicone rubber graft copolymer as claimed in claim 1, wherein the concentration of initiator in the reaction vessel is kept below 0.05% by weight, based on the entire reaction mixture.

7: The silicone rubber graft copolymer as claimed in claim 1, wherein between the core a) and the shell c) there is another spherical polydialkylsiloxane layer b) present, comprising (R₂SiO_{2/2}) units.

8: The silicone rubber graft copolymer as claimed in claim 1, wherein the particle diameter of the silicone rubber graft copolymer is in the range from 10 to 300 nm.

9: The silicone rubber graft copolymer as claimed in claim 1, wherein the graft copolymer comprises
from 0.05 to 95% by weight, based on the total weight of the copolymer, of a core a) comprising an organosilicon polymer,
from 0 to 94.5% by weight, based on the total weight of the copolymer, of a polydialkylsiloxane layer b), and
from 5 to 95% by weight, based on the total weight of the copolymer, of a shell c) comprising at least one organic polymer.

10: The silicone rubber graft copolymer as claimed in claim 1, wherein the shell c) comprises at least one polymerized (meth)acrylate.

11: The silicone rubber graft copolymer as claimed in claim 10, wherein the shell c) is prepared via polymerization of a mixture in which methacrylates and acrylates are present.

12: The silicone rubber graft copolymer as claimed in claim 11, wherein the shell c) is prepared via polymerization of a mixture in which methyl methacrylate and at least one acrylate having from 1 to 8 carbon atoms are present.

13: The silicone rubber graft copolymer as claimed in claim 1, wherein vinyl groups are present in the core a) prior to preparation of the organic shell c).

14: The silicone rubber graft copolymer as claimed in claim 13, wherein the content of the vinyl groups in the core a) is in the range from 2 to 3 mol %, based on the weight of the core.

15: A process for preparing a silicone rubber graft copolymer as claimed in claim 1, wherein a core is prepared from polysiloxane by the emulsion polymerization process, and then organic monomers are grafted onto the resultant polysiloxane by a free-radical route, the initiator being added continuously during the free-radical polymerization.

16: The process as claimed in claim 15, wherein butyl hydroperoxide is used as initiator.

17: A molding composition comprising at least one silicone rubber graft copolymer as claimed in claim 1.

18: The molding composition as claimed in claim 17, wherein the molding composition comprises at least one poly(meth)acrylate.

19: The molding composition as claimed in claim 17, wherein the molding composition comprises at least one styrene-acrylonitrile polymer.

20: The molding composition as claimed in claim 19, wherein the at least one styrene-acrylonitrile polymer is prepared via polymerization of a mixture which comprises
from 70 to 92% by weight of styrene
from 8 to 30% by weight of acrylonitrile, and
from 0 to 22% by weight of other comonomers, based in each case on the total weight of the monomers to be polymerized.

21: The molding composition as claimed in claim 17, wherein the molding composition further comprises at least one acrylate-rubber-based impact modifier.

22: The molding composition as claimed in claim 17, wherein the molding composition comprises
f1) from 0 to 95% by weight of at least one (meth)acrylate polymer,
f2) from 0 to 45% by weight of at least one styrene-acrylonitrile polymer,
f3) from 5 to 60% by weight of at least one silicone rubber graft copolymer,
f4) from 0 to 60% by weight of at least one polyacrylate-rubber-based impact modifier, based in each case on the weight of components f1) to f4) and conventional additives.

23: An impact-resistant molding produced from the molding composition as claimed in claim 17.

24: The impact-resistant molding as claimed in claim 23, wherein the molding has a Vicat softening point according to ISO 306 (B50) of at least 85° C., a notched impact strength NIS (Izod 180/1eA, 1.8 MPa) according to ISO 180 of at least 3.0 kJ/m² at −20° C. and of at least 2.5 kJ/m² at −40° C., a modulus of elasticity according to ISO 527-2 of at least 1500 MPa.

25: The silicone rubber graph copolymer as claimed in claim 1, wherein the initiator is added in at least three portions, at least 10 minutes apart.

26: The silicone rubber graph copolymer as claimed in claim 1, wherein the initiator is added in at least three portions, at least 20 minutes apart.

27: The silicone rubber graph copolymer as claimed in claim 1, wherein the weight ratio of the amount of the initiator added during the polymerization to the amount of the initiator present at the start of polymerization is at least 20.
